(19) United States
(12) Patent Application Publication
(10) Pub. No.: US 2012/0008655 A1
(43) Pub. Date: Jan. 12, 2012

(54) HEAT SINK, METHOD OF PRODUCING SAME, AND SEMICONDUCTOR LASER DEVICE

(75) Inventor: Yoshiaki Niwa, Kanagawa (JP)

(73) Assignee: SONY CORPORATION, Tokyo (JP)

(21) Appl. No.: 13/154,073

(22) Filed: Jun. 6, 2011

(30) Foreign Application Priority Data
Jul. 8, 2010 (JP) 2010-155836

(51) Int. Cl. H01S 3/04; B21D 53/02; F28F 7/00

(52) U.S. Cl. 372/36; 165/185; 29/890.054

(57) ABSTRACT

A heat sink enabled to prevent structural deterioration of an inner wall of a flow channel caused by corrosion a semiconductor laser device are provided. The heat sink includes a main body, a flow channel which is provided in the main body, and inside which a cooling medium passes through, and a passivation film covering an inner-wall surface of the flow channel.

### BACKGROUND

The present disclosure relates to a heat sink having a flow channel through which a cooling medium passes, a method of producing the heat sink, and a semiconductor laser device having a semiconductor laser element implemented at such a heat sink.

In a semiconductor laser device producing high outputs in a range of several watts to tens of watts, a heat sink is used to efficiently radiate (cool) heat generated by a semiconductor laser. As this heat sink, there is known a microchannel heat sink having a minute flow-channel structure inside which a cooling medium such as water or the like passes through.

Typically, this type of microchannel heat sink is configured by laminating thin plates as illustrated in FIG. 9. In other words, a heat sink 100 has a cooling thin plate 101 mounted with a semiconductor laser element and provided for cooling, an upper radiating-fin forming thin plate 102, a partitioning thin plate 103, a lower radiating-fin forming thin plate 104, and a coolant inflow outlet thin plate 105. The respective thin plates are bonded under a high temperature pressurized condition by bonding metal. Liquid phase diffusion bonding, brazing, or the like is used as a bonding method.

In order to prevent a minute structural part from being buried as a result of the bonding metal melting when the liquid phase diffusion bonding is performed, the cooling thin plate 101, the partitioning thin plate 103, and the coolant inflow outlet thin plate 105 are plated with the bonding metal, while the upper radiating-fin forming thin plate 102 and the lower radiating-fin forming thin plate 104 each having a microstructure are not plated, for example. When the layers are bonded after being plated alternately in this way, an inner wall of the flow channel has a structure in which different kinds of metal are exposed. In other words, in this structure, a part where a base material is exposed and a part where the bonding metal is exposed are mixed in the flow channel.

However, this structure has such a disadvantage that galvanic corrosion occurs with the passage of time-of-use. The galvanic corrosion is a phenomenon in which when dissimilar metals come into contact with each other in a cooling medium, ions move and thereby a base metal in terms of ionization tendency thins (reduces). Specifically, when dissimilar metals are in contact with each other in a cooling medium, a potential difference occurs between the dissimilar metals via the cooling medium. When the cooling medium is caused to circulate for a long time of about several thousand hours in this state, thinning occurs on the base metal (e.g., copper) side in the heat sink, whereas deposition and adhesion of a corrosion product occur on a precious metal (e.g., gold or silver) side, due to an electrochemical mechanism of a wetted part. As a result, structural disorder (degradation in coolability based on several thousand hours of water conduction) in the flow channel, or conduction with an external wall of the heat sink (a leakage of the cooling medium based on several thousand hours of water conduction) occurs, causing a decrease in reliability to serve as the heat sink.

To address such a disadvantage, the following methods have been suggested. A first method is a method in which thin plates 111 to 115 are bonded by solid-phase diffusion bonding without bonding metal in between as illustrated in FIG. 10A. A second method is a method in which a surface of each of thin plates 111 to 115 is plated with a bonding metal 120 and then these thin plates are bonded as illustrated in FIG. 10B. A third method is a method in which only a bonded part of each of thin plates 111 to 115 is coated with a bonding metal 120 and thereby these thin plates are bonded as illustrated in FIG. 10C (see, for example, Japanese Unexamined Patent Application Publication No. 2008-300596). An inner wall of a flow channel of each of heat sinks 110A to 110C produced by the respective methods described above has a configuration in which a single metal or approximately only a base material is exposed. Therefore, it is assumed that in the heat sinks 110A and 110B illustrated in FIG. 10A and FIG. 10B, respectively, the galvanic corrosion to occur between dissimilar metals as described above may not take place, and long-term use may be possible. Further, it is also assumed that the heat sink 110C illustrated in FIG. 10C may suppress the occurrence of the galvanic corrosion.

### SUMMARY

However, it is difficult to completely prevent the galvanic corrosion or the like from occurring, through any of the methods described above. In the form illustrated in FIG. 10C, it is structurally difficult to completely suppress corrosive action. In the form illustrated in FIG. 10B, elution of the bonding metal covering the inner wall of the flow channel is caused by erosion due to circulation of a cooling medium and thereby a base material is exposed, and as a result, the galvanic corrosion occurs. In the form illustrated in FIG. 10A, the galvanic corrosion is suppressed, but in a case where a heat sink used as a microchannel heat sink in general usage is used as a conduction path for supplying power to a semiconductor laser element, elution of the metal of the heat sink into a cooling medium is caused by a potential difference with respect to the cooling medium, i.e., thinning occurs, making it difficult to use the heat sink eventually.

In view of the foregoing, it is desirable to provide: a heat sink enabled to prevent structural deterioration of an inner wall of a flow channel caused by corrosion such as the galvanic corrosion and thereby improve reliability; a method of producing this heat sink; and a semiconductor laser device in which a semiconductor laser element is implemented on such a heat sink.

According to an embodiment of the present disclosure, there is provided a heat sink which includes a main body with a flow channel inside which a cooling medium passes through, and in which an inner-wall surface of the flow channel is covered with a passivation film.

According to an embodiment of the present disclosure, there is provided a method of producing a heat sink, the method including the following (A) to (C):

(A) plating a plurality of thin plates, at least one of which has a flow channel inside which a cooling medium passes through, with a passivated metal;
(B) forming a heat-sink main body in which the plurality of thin plates are bonded with the passivated metal in between, and which has the flow channel; and
(C) forming a passivation film on an inner wall of the flow channel by oxidizing the passivated metal.

Here, “the passivated metal” is a metal capable of forming a passivation film by oxidization and may be, for example, nickel (Ni), chromium (Cr), tin (Sn), titanium (Ti), tantalum (Ta), cobalt (Co), lead (Pb), niobium (Nb), antimony (Sb), zirconium (Zr), aluminum (Al), or an alloy of these metals.

According to an embodiment of the present disclosure, there is provided a semiconductor laser device in which a semiconductor laser element is implemented at the heat sink according to the above-described embodiment of the present disclosure.

In the heat sink and the semiconductor laser device according to the embodiments of the present disclosure, the inner-wall surface of the flow channel is covered with the passivation film that is chemically stable and thus, corrosion resistance is improved.

In the method of producing the heat sink according to the embodiments of the present disclosure, after the plurality of thin plates are bonded with the passivated metal in between, the passivated metal is oxidized and thereby the passivation film is formed on the inner wall of the flow channel and thus, it is possible to produce a heat sink with improved corrosion resistance while maintaining an existing process.

According to the heat sink (the semiconductor laser device) and the method of producing the heat sink in the embodiments of the present disclosure, the inner-wall surface of the flow channel is covered with the passivation film that is chemically stable and thus, it is possible to prevent corrosion caused by a potential difference, such as galvanic corrosion. In other words, it is possible to prevent structural deterioration in the inner wall of the flow channel, while maintaining an existing process, and improve reliability.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional diagram illustrating a semiconductor laser device according to a first embodiment of the present disclosure.

FIG. 2 is an exploded perspective view of a heat sink illustrated in FIG. 1.

Parts (A) to (D) of FIG. 3 are production process diagrams illustrating a method of producing the heat sink.

FIG. 4 is a perspective diagram illustrating an appearance of the semiconductor laser device illustrated in FIG. 1.

FIG. 5 is a cross-sectional diagram illustrating a semiconductor laser device according to a second embodiment of the present disclosure.

FIG. 6 is a cross-sectional diagram illustrating a semiconductor laser device according to a third embodiment of the present disclosure.

Parts (A) to (C) of FIG. 7 are production process diagrams illustrating a method of producing the heat sink according to the third embodiment of the present disclosure.

FIG. 8 is an exploded perspective view of a heat sink according to a modification of the present disclosure.

FIG. 9 is an exploded perspective view illustrating an example of a semiconductor laser device of related art.

FIGS. 10A to 10C are cross-sectional diagrams of a heat sink of related art.

### DETAILED DESCRIPTION OF EMBODIMENTS

Embodiments of the present disclosure will be described below in detail with reference to the drawings. Incidentally, the description will be provided in the following order.

1. First embodiment (a technique of performing a passivation treatment, after plating a metal thin plate in its entirety with a passivated metal and forming a flow channel.)
2. Second embodiment (a technique of performing a passivation treatment, after forming a flow channel and plating an interior of the flow channel with a passivated metal.)
3. Third embodiment (a technique of performing a passivation treatment, after coating only a part-to-become-inner-wall of the flow channel with a passivated metal or a nonmetal capable of forming a passivation film and then forming a flow channel.)

### 4. Modification

### First Embodiment

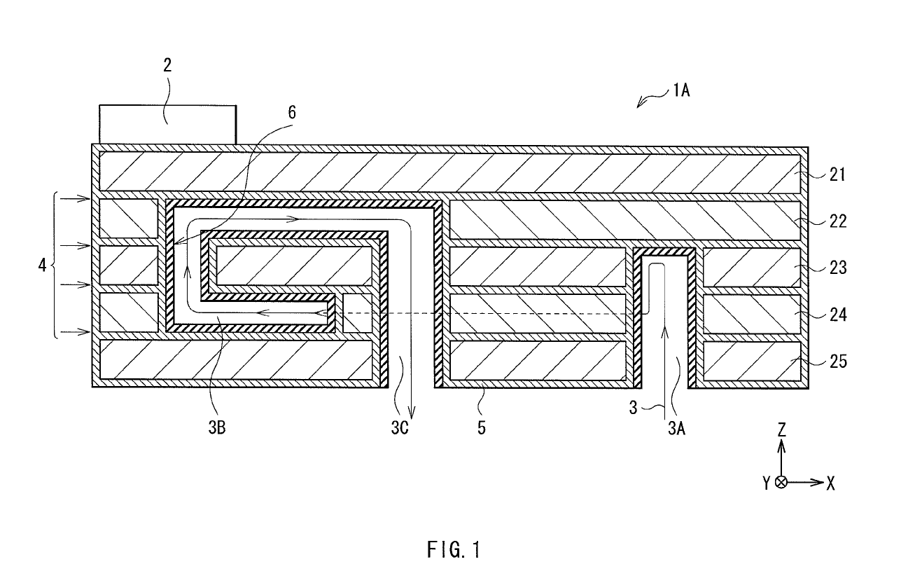

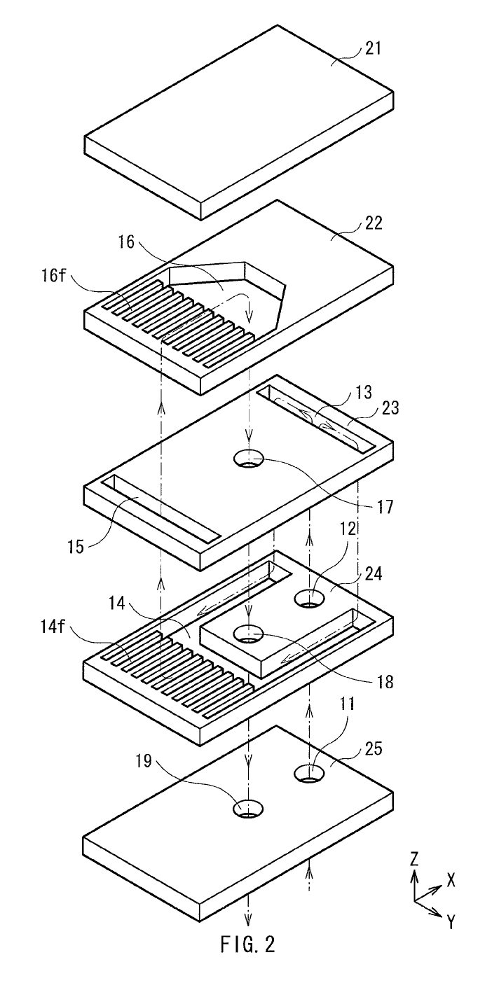

FIG. 1 illustrates a cross-sectional configuration of a semiconductor laser device according to the first embodiment of the present disclosure. FIG. 2 illustrates an example of a specific inner structure of a heat sink 1A applied to this semiconductor laser device.

In this semiconductor laser device, a semiconductor laser element 2 is mounted on the heat sink 1A of microchannel type having a minute flow-channel structure. The semiconductor laser element 2 is a single laser element having one emission point or an array laser element having two or more emission points. The heat sink 1A (main body) has a structure in which a plurality of thin plates are laminated and bonded, and a flow channel 3 (a supply flow channel 3A, a middle flow channel 3B, and a discharge flow channel 3C) through which a cooling medium passes is formed inside. In the present embodiment, five thin plates in total, namely, a first layer 21, a second layer 22, a third layer 23, a fourth layer 24, and a fifth layer 25 are layered by disposing the first layer 21 as an uppermost layer. In addition, a passivation film 6 is formed on a surface of an inner wall (a sidewall face, a bottom, and a ceiling) of the flow channel 3.

It is preferable that each of the layers 21 to 25 of the heat sink 1A be formed of a thin plate made of a single metallic material. As a specific base material, it is desirable to use copper (Cu) having high thermal conductivity and suitable for processing, but the base material is not limited to Cu, and other material such as silver (Ag) or gold (Au) may be used.

The first layer 21 is mounted with the semiconductor laser element 2 on a top surface, and provided to perform cooling. The second layer 22 is a radiating-fin forming plate, and has a middle flow-channel forming section 16 and radiating fins 16f as illustrated in FIG. 2. The middle flow-channel forming section 16 is formed to pass through the second layer 22 vertically. The plurality of radiating fins 16f are arranged in parallel at a position corresponding to a lower part of a mounting position of the semiconductor laser element 2, and the cooling medium runs through the radiating fins 16f.

Similarly, the fourth layer 24 is also a radiating-fin forming plate, and has a middle flow-channel forming section 14 and radiating fins 14f as illustrated in FIG. 2. The fourth layer 24 further has a supply flow-channel forming aperture 12 and a discharge flow-channel forming aperture 18. The supply flow-channel forming aperture 12 and the discharge flow-channel forming aperture 18 pass through the fourth layer 24 vertically.

The third layer 23 has middle flow-channel forming sections 13 and 15, and a discharge flow-channel forming aperture 17. The middle flow-channel forming sections 13 and 15 and the discharge flow-channel forming aperture 17 each pass through the third layer 23 vertically. The middle flow-channel forming sections 13 and 15 are each formed to be, for example, rectangular, and the middle flow-channel forming section 13 is located on the supply flow-channel forming aperture 12 of the second layer 22, whereas the middle flow-channel forming section 15 is located between the radiating fins 16f of the second layer 22 and the radiating fins 14f of the fourth layer 24.

The fifth layer 25 has a supply flow-channel forming aperture 11 and a discharge flow-channel forming aperture 19. The supply flow-channel forming aperture 11 and the discharge flow-channel forming aperture 19 pass through the fifth layer 25 vertically.

The supply flow-channel forming aperture 11 of the fifth layer 25, the supply flow-channel forming aperture 12 of the fourth layer 24, and the middle flow-channel forming section 13 of the third layer 23 are provided at respective positions vertically corresponding to one another, which thereby as a whole form the supply flow channel 3A through which the cooling medium passes in a direction from a lower layer side to an upper layer side. The middle flow-channel forming section 14 and the radiating fins 14f of the fourth layer 24, the middle flow-channel forming section 15 of the third layer 23, and the radiating fins 16f and the middle flow-channel forming section 16 of the second layer 22 are sequentially disposed from a side where the cooling medium passes, and as a whole form the middle flow channel 3B where the cooling medium after passing through the supply flow channel 3A runs. The discharge flow-channel forming aperture 17 of the third layer 23, the discharge flow-channel forming aperture 18 of the fourth layer 24, and the discharge flow-channel forming aperture 19 of the fifth layer 25 are disposed at respective positions vertically corresponding to one another, which thereby as a whole form the discharge flow channel 3C where the cooling medium after passing through the middle flow channel 3B runs in a direction from an upper layer side to a lower layer side.

The flow channel 3 is formed by laminating the first to fifth layers 21 to 25, and the passivation film 6 is formed on its inner wall surface. This passivation film 6 is an oxide film of a bonding metal 5 with which the entire surfaces of the first to fifth layers 21 to 25 are plated. As the bonding metal 5, it is desirable to employ a metal suitable for solid-state diffusion bonding in which the metal diffuses with a base material (e.g., Cu) of the first to fifth layers 21 to 25 at a low temperature and becomes an alloy, thereby improving bondability of each layer. Examples of the metal include tin (Sn), nickel (Ni), chromium (Cr), and the like, becoming an alloy at a low temperature. Further, for example, metal alloys such as CuNi, Cu₆Sn₅, Cu₃Sn, and the like based on the metals mentioned above may be used. The thickness of the bonding metal 5 with which the first to fifth layers 21 to 25 is plated is, for example, 1 to 10 μm, and of this, the thickness of the passivation film 6 formed by oxidization is tens of Å (several nm). As a method of forming the passivation film 6, for example, strong oxidation treatment using nitric acid, nitric hydrofluoric acid, concentrated sulfuric acid, or the like, or annealing treatment at 300° C. to 700° C. may be employed.

In this semiconductor laser device, the supply flow channel 3A and the discharge flow channel 3C of the heat sink 1A are connected to a circulator (not illustrated) called tiller that performs supply and discharge of the cooling medium and temperature control. In the heat sink 1A, when the cooling medium (coolant) is supplied to the supply flow channel 3A, this cooling medium flows from the supply flow channel 3A to the middle flow channel 3B as described above. Subsequently, the cooling medium is discharged from the discharge flow channel 3C. The semiconductor laser element 2 converts an electrical signal received from a driving circuit (not illustrated) into an optical signal, and outputs this optical signal. Heat generated as a result of the semiconductor laser element 2 being driven is transmitted to the inside of the heat sink 1A from a laser-chip mounting board (the first layer 21). Inside the heat sink 1A, the radiating fins 14f and 16f are provided at positions corresponding to the semiconductor laser element 2 being mounted. Therefore, due to the flow of the cooling medium along the flow channel 3, the heat received from the semiconductor laser element 2 is dissipated efficiently. As a result, the semiconductor laser element 2 is cooled.

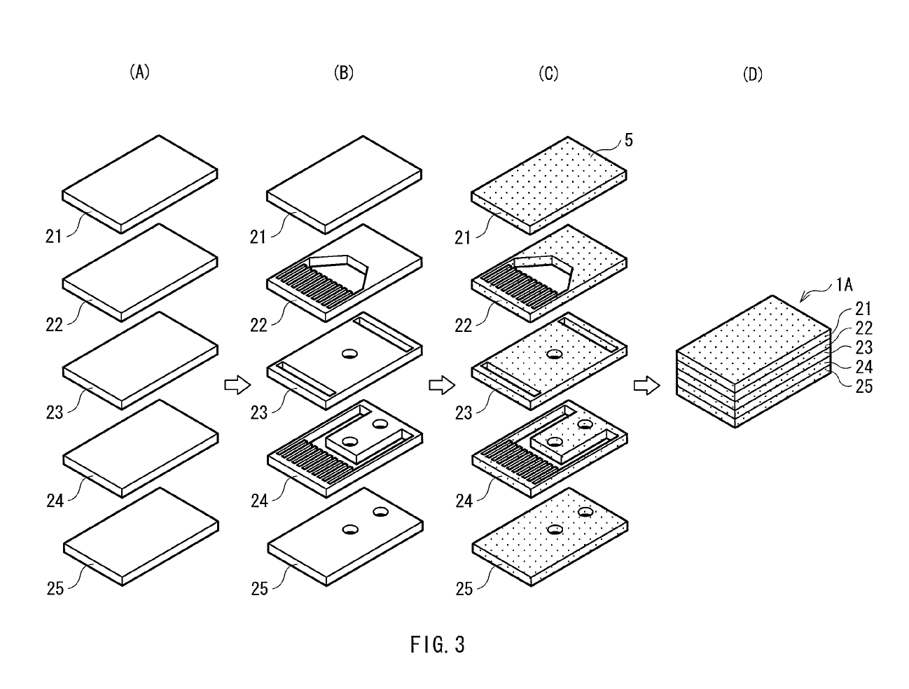

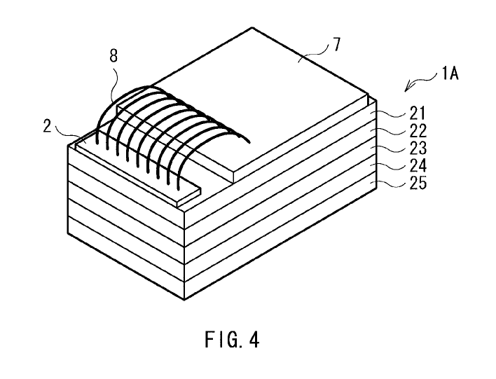

Next, a method of producing the heat sink 1A and the semiconductor laser device will be described with reference to FIG. 3 and FIG. 4.

First, as illustrated in Part (A) of FIG. 3, for example, a base material sheet having a thickness of 0.2 to 1 mm is prepared for each of the layers 21 to 25. Subsequently, as illustrated in Part (B) of FIG. 3, the base material sheet is etched and thereby a flow-channel structure including the fins and the like is formed. Specifically, a process of producing a typical microchannel heat sink may be applied, and the flow-channel structure is formed with precision by, for example, cutting, diecutting suitable for mass production, etching enabling further minute processing, or the like.

Subsequently, as illustrated in Part (C) of FIG. 3, each of the layers 21 to 25

is plated with, for example, Ni to serve as the bonding metal 5, and thereby a Ni film having a thickness of 2 to 5 μm is formed. Next, as illustrated in Part (D) of FIG. 3, the layers 21 to 25 are laminated, and pressurized at a high temperature (e.g., 300° C. to 800° C. both inclusive), with a high pressure (e.g., several to tens of MPa), and thereby the layers 21 to 25 are bonded by solid-phase diffusion bonding in a vacuum or in an atmosphere of argon. As a result, the flow channel 3 inside of which is coated with a metal capable of being passivated is formed. Here, the solid-phase diffusion bonding is to perform bonding between solidus surfaces in a solid-phase state, and the bonding is performed at a temperature equal to or lower than the melting point of a bonding material. For this reason, at the time of bonding, the inside of the flow channel 3 is allowed to have a structure with small nonuniformity of material.

Next, the passivation film 6 is formed on an inner-wall surface of the flow channel 3. Specifically, in the flow channel 3, for example, the Ni film is subjected to a passivation treatment by circulating a nitric acid solution having a concentration of 30 to 50% for 15 minutes, and thereby the passivation film 6 made of NiO₂ is formed on the inner-wall surface of the flow channel. This completes the heat sink 1A.

Subsequently, the semiconductor laser element 2 is mounted on the heat sink 1A as illustrated in FIG. 4. Specifically, the periphery of the heat sink 1A is plated with, for example, Ni/Au, and the semiconductor laser element 2 is mounted at a position corresponding to the radiating fins 16f on the first layer 21, by using, for example, AuSn solder. Other type of solder such as SnAgCu solder or In solder of low stress may be used as the solder. Lastly, the semiconductor laser element 2 and an electrode 7 are electrically connected to each other using wiring 8 such as Au wire or Au ribbon, and thereby the semiconductor laser device is completed.

In the present embodiment, the entire inner wall of the flow channel 3 of the heat sink 1A is covered with the passivation film 6 that is resistant to corrosive action and stable, and therefore, a microstructure in the heat sink 1A is not eroded even when the cooling medium flows for a long time. Further, the galvanic corrosion described earlier does not occur and thus, reliability improves. Furthermore, the heat sink 1A itself serves as a conduction path for supplying power to the semiconductor laser element 2 and thus, a potential difference may be produced between the heat sink 1A and the cooling medium, but even if the potential difference is produced, occurrence of electrolytic corrosion is suppressed by this passivation film 6.

As described above, in the heat sink 1A and the semiconductor laser device of the present embodiment, the passivation film 6 is formed on the entire inner wall of the flow channel 3 and thus, it is possible to prevent erosion in the microstructure including the fins and the like, caused by the flow of the cooling medium. This makes it possible to maintain high cooling efficiency from an early stage. Further, the inside of the flow channel 3 is covered by the passivation film 6 which is a single film and thus, the inside of the flow channel 3 is in a state of no dissimilar metals coexisting, and deterioration in the structure of the inner wall of the flow channel due to the galvanic corrosion is prevented and reliability improves. Furthermore, electrolytic corrosion, which may take place when the heat sink 1A is used for the conduction path for supplying the power to the semiconductor laser element 2, is prevented from occurring and thus, long-term use is allowed.

In addition, in the method of producing the heat sink 1A of the present embodiment, a process of producing a typical microchannel heat sink may be used, by merely adding the passivation treatment process based on the circulation of the strong acid such as nitric acid in the flow channel 3 or the annealing treatment, after the process of bonding the thin plates. In other words, it is possible to provide a reliable heat sink, while nearly maintaining small external dimensions and a process therefore. In addition, the heat sink 1A may be produced without using a precious metal such as Ag or Au and thus, it is possible to reduce the cost.

Now, other embodiments of the present disclosure will be described below, but the elements substantially same as those of the first embodiment will be provided with the same reference characters as those of the first embodiment and the description will be omitted as appropriate.

### Second Embodiment

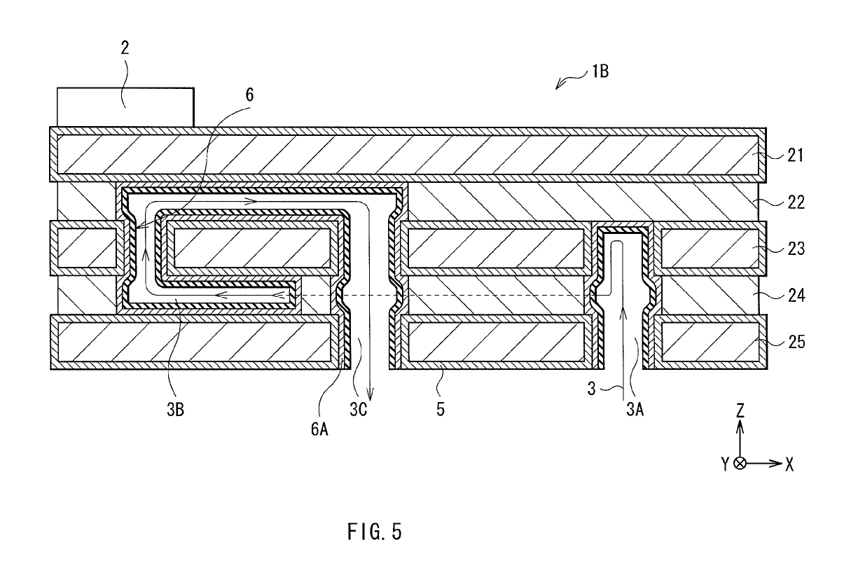

FIG. 5 illustrates a semiconductor laser device according to the second embodiment. The semiconductor laser device according to the present embodiment has a heat sink 1B in place of the heat sink 1A (FIG. 1) in the first embodiment. This heat sink 1B is basically the same as the heat sink 1A of the first embodiment in terms of basic structure, and only differs in the type of the bonding metal 5 of each of the layers 21 to 25 and the method of producing the passivation film 6.

In the present embodiment, at first, the surface of the thin plate of every other layer, e.g., a first layer 21, a third layer 23, and a fifth layer 25 is plated with, for example, Ag serving as a bonding metal 5. Subsequently, the layers 21 to 25 are bonded by the solid-phase diffusion bonding and thereby the flow channel 3 is formed. It is to be noted that each of the layers 21 to 25 may be plated in a manner similar to the first embodiment. Subsequently, for example, a plating solution for plating with a passivated metal 6A such as tantalum (Ta) is flowed into a flow channel 3, and a film of the passivated metal 6A is formed on an inner wall of the flow channels by, for example, electroplating in which less pinholes are formed. Subsequently, in a manner similar to the first embodiment, a passivation treatment is applied to the passivated metal 6A in the flow channel 3, and thereby the passivation film 6 is formed on the inner wall of the flow channel 3. It is to be noted that the bonding metal 5 is not limited to Ag, and other metal such as Au may be employed.

Finally, in a manner similar to the first embodiment, the periphery of the heat sink 1B is plated with, for example, Ni/Au, and a semiconductor laser element 2 is mounted using, for example, AuSn solder and then, as illustrated in FIG. 4, the semiconductor laser element 2 and the electrode 7 are electrically connected to each other by the wiring 8, and thereby the semiconductor laser device is completed.

In this way, in the present embodiment, a plating process of the passivated metal 6A is added after a typical flow-channel forming process, but this plating of the passivated metal may be applied only to the inner wall of the flow channel 3, unlike the first embodiment. Therefore, the passivated metal may be selected freely. In other words, as the metal to be used for plating in the flow channel 3, Ta, Ti, and Nb that are metals easy to passivate may be used, in addition to Sn, Cr, Ni, and alloys thereof which are used in the first embodiment. Moreover, other metals such as iron (Fe), Co, Pb, and Sb may also be used.

As described above, in the heat sink 1B and the semiconductor laser device of the present embodiment, after the flow channel 3 is formed, the inside of the flow channel 3 is plated with the passivated metal 6A, and the passivation treatment is performed. Therefore, in addition to the effects of the first embodiment, a metal capable of being passivated may be selected freely. Therefore, various kinds of metal such as Ta, Ti, and Nb may be used, making it possible to form the passivation film 6 more easily.

### Third Embodiment

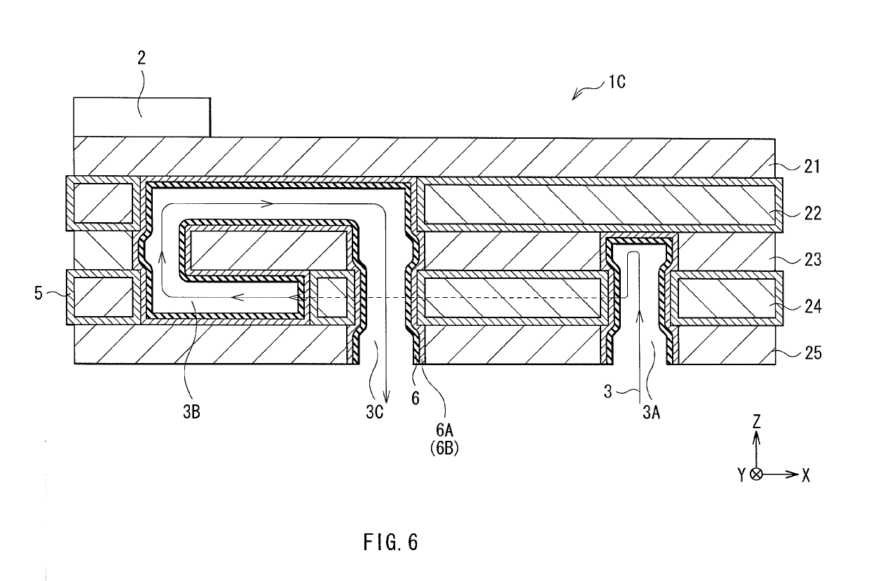

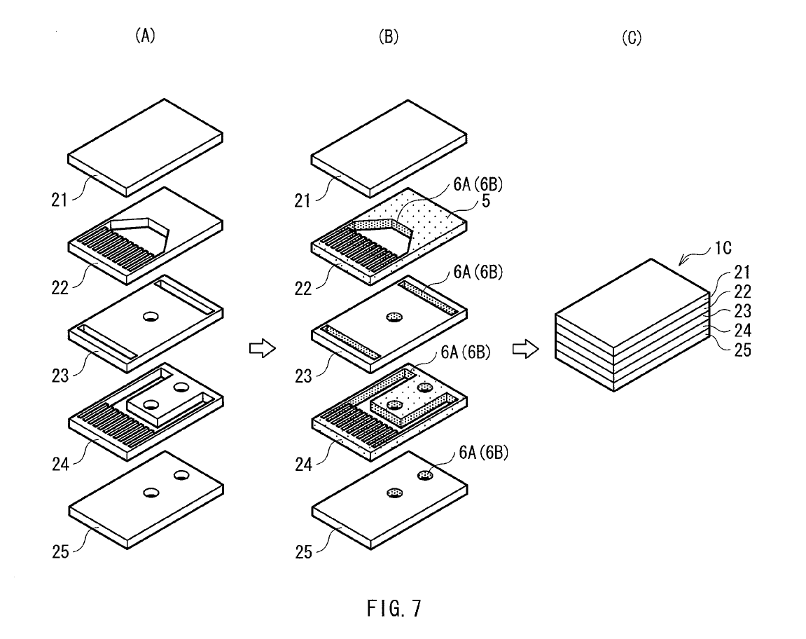

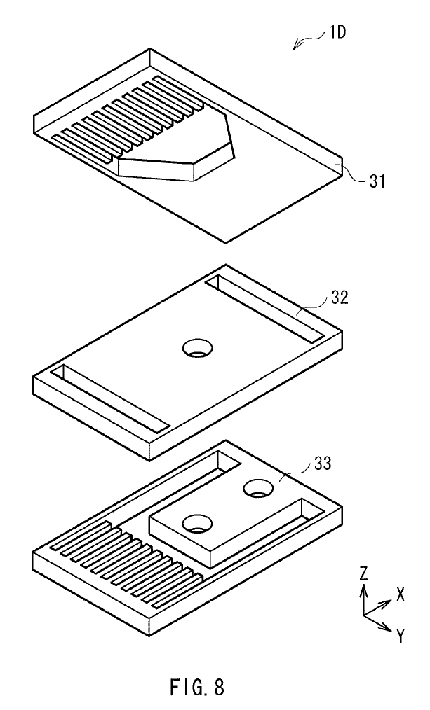

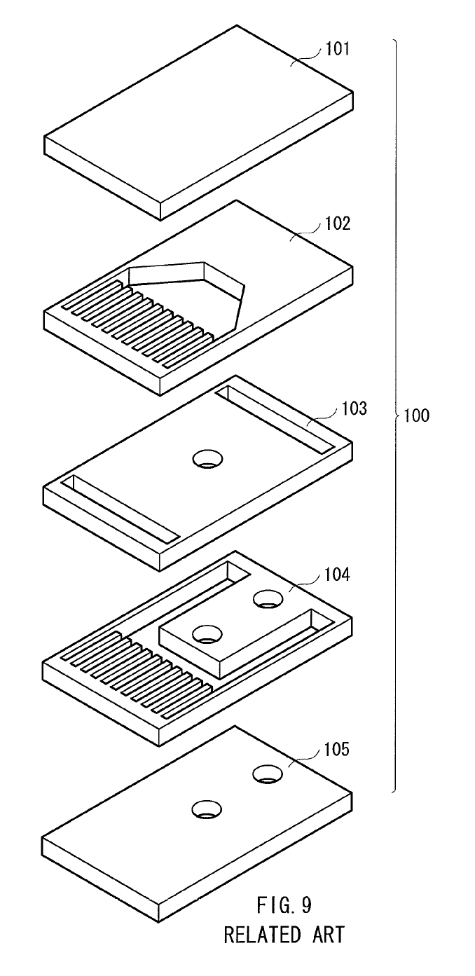

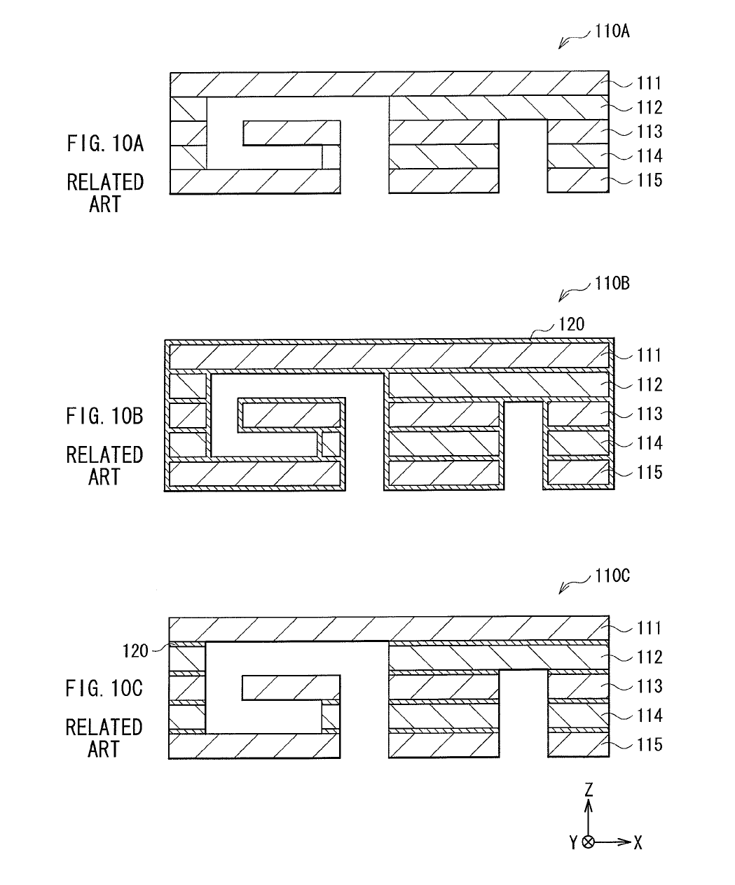

FIG. 6 illustrates a semiconductor laser device according to the third embodiment of the present disclosure. This semiconductor laser device includes a heat sink 1C in place of the heat sink 1A (FIG. 1) described above. This heat sink 1C is similar to the heat sink 1A in terms of basic structure, and only differs in the type of the bonding metal 5 of each of the layers 21 to 25 and the method of forming the passivation film 6.

In the heat sink 1C of the present embodiment, after every other one of layers 21 to 25 is plated with a bonding metal 5 such as Ag, a surface to become a flow channel 3 is coated, prior to bonding, with a metal 6A or a nonmetal 6B capable of being passivated. Incidentally, for the reason described above, it is desirable to select the first layer 21, the third layer 23 and the fifth layer 25 as the thin plates targeted for plating, in a manner similar to the second embodiment, but the second layer 22 and the fourth layer 24 may be selected. In the present embodiment, an example in which the second layer 22 and the fourth layer 24 are plated will be described.

FIG. 7 illustrates a process of producing this heat sink 1C. First, as illustrated in Part (A) of FIG. 7, a base material sheet is etched and thereby a flow-channel structure including fins and the like is formed, in a manner similar to the first embodiment. Next, as illustrated in Part (B) of FIG. 7, the second layer 22 and the fourth layer 24 are plated with a bonding metal 5, e.g., Ag. Subsequently, each bonded part of the layers 21 to 25 is masked, and a part to become the flow channel 3 when the layers 21 to 25 are laminated is coated with a passivated metal 6A (e.g., zirconium (Zr) or, aluminum (Al)) or a nonmetal 6B (e.g., silicon (Si)) capable of being passivated. It is to be noted that the bonding metal 5 is not limited to Ag, and other metal such as Au may be employed.

Next, as illustrated in Part (C) of FIG. 7, the layers 21 to 25 are laminated and bonded by solid-phase diffusion bonding, and thereby the flow channel 3 is formed. Subsequently, in a manner similar to the first embodiment, a passivation treatment is applied to the passivated metal 6A (or the nonmetal 6B capable of being passivated) in the flow channel 3, and a passivation film 6 is formed on an inner wall of the flow channel 3. This completes the heat sink 1C. Lastly, a semiconductor laser element 2 is mounted on the heat sink 1C, and wiring of the semiconductor laser element 2 is carried out.

In this way, in the present embodiment, a process of masking the bonded part and coating the part to become the flow channel 3 with the passivated metal 6A (or the nonmetal 6B capable of being passivated) are added to a typical production process. Therefore, unlike the embodiments described above, a nonmetal difficult to use for coating such as Si or a metal unsuitable for plating such as Zr and Al may be selected.

As described above, in the heat sink 1C and the semiconductor laser device of the present embodiment, after every other one or each of the layers 21 to 25 is plated with the bonding metal 5 such as Ag, the bonded surface of each of the layers 21 to 25 is masked, and the part to become the flow channel 3 is coated with the passivated metal 6A (or the nonmetal 6B capable of being passivated). Therefore, in addition to the metal unsuitable for plating, a nonmetallic element such as Si may be employed as the passivation film and thus, a covalent passivation film more stable than a passivation film derived from metal may be formed. This makes it possible to further improve the reliability of the heat sink.

### [Modification]

In the first to third embodiments described above, the flow channel 3 is formed using the five thin plates. However, the number of laminated thin plates is not limited to five, and, for example, a three-layer structure including a first layer 31, a second layer 32, and a third layer 33 may be employed, as a heat sink 1D illustrated in FIG. 8. The first layer 31 is a combination of the cooling thin plate (the first layer 21) and the upper radiating-fin forming thin plate (the second layer 22) described above. The second layer 32 is equivalent to the third layer 23 described above, and has middle flow-channel forming sections 13 and 15 and a discharge flow-channel forming aperture 17. The third layer 33 is a combination of the lower radiating-fin forming thin plate (the fourth layer 24) and the coolant inflow outlet thin plate (the fifth layer 25). The first layer 31 and the third layer 33 may be formed by cutting or half etching.

In this way, according to the present modification, the cooling thin plate and the upper radiating-fin forming thin plate are combined, and also the lower radiating-fin forming thin plate and the coolant inflow outlet thin plate are combined, by cutting or half etching. Therefore, it is possible to reduce the number of components and parts to be bonded. This makes it possible to reduce the cost, and also improve the reliability.

The first to third embodiments and the modification have been described. However, the present technology is not limited to the embodiments and like, and may be variously modified. For example, the flow-channel structure described above in each of the embodiments and the like is not limited to those illustrated in the figures, and may be other structure.

Further, the heat sink 1A is formed by using the five thin plates in the first embodiment, but each of the upper radiating-fin forming thin plate (the second layer 22) and the lower radiating-fin forming thin plate (the fourth layer 24) may be provided as two or more plates. This makes it possible to increase a cross-sectional area of the flow channel, thereby reducing a pressure drop of the flow channel.

Furthermore, each of the heat sinks 1A to 1D described above is used as a radiation member of the semiconductor laser element 2, but these heat sinks are not limited to this use, and may be applied as a radiation member of a semiconductor element other than the semiconductor laser element.

The present disclosure contains subject matter related to that disclosed in Japanese Priority Patent Application JP 2010-155836 filed in the Japan Patent Office on Jul. 8, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A heat sink comprising:
a main body;
a flow channel which is provided in the main body, and inside which a cooling medium passes through; and
a passivation film covering an inner-wall surface of the flow channel.

2. The heat sink according to claim 1, wherein the passivation film is an oxide film made of nickel (Ni), tin (Sn), titanium (Ti), tantalum (Ta), iron (Fe), cobalt (Co), lead (Pb), aluminum (Al), silicon (Si), zirconium (Zr), niobium (Nb), antimony (Sb), or an alloy thereof.

3. The heat sink according to claim 1, wherein the main body has a layered structure including a plurality of thin plates, and has the flow channel in at least one of the plurality of thin plates.

4. The heat sink according to claim 3, wherein the thin plates are made of copper (Cu), silver (Ag), or gold (Au).

5. The heat sink according to claim 3, wherein the plurality of thin plates are bonded to each other by a passivated metal serving as a bonding metal, and the passivation film is an oxide film made of the bonding metal.

6. The heat sink according to claim 5, wherein the passivated metal is Sn, Ni, Cr, or an alloy thereof.

7. The heat sink according to claim 3, wherein the plurality of thin plates are bonded to each other by a bonding metal of silver (Ag) or gold (Au).

8. A method of producing a heat sink, the method comprising:
plating a plurality of thin plates, at least one of which has a flow channel inside which a cooling medium passes through, with a passivated metal;
forming a heat-sink main body in which the plurality of thin plates are bonded with the passivated metal in between, and which has the flow channel; and
forming a passivation film on an inner wall of the flow channel by oxidizing the passivated metal.

9. The method of producing the heat sink according to claim 8, wherein the plurality of thin plates are bonded by solid-phase diffusion bonding.

10. A semiconductor laser device comprising:
a heat sink; and
a semiconductor laser element implemented at the heat sink,
wherein the heat sink includes
a main body,
a flow channel which is provided in the main body, and inside which a cooling medium passes through, and
a passivation film covering an inner-wall surface of the flow channel.
